(19) United States
(12) Patent Application Publication
(10) Pub. No.: US 2015/0301183 A1
(43) Pub. Date: Oct. 22, 2015

(54) LOW BANDWIDTH METHOD FOR EPHEMERIS RECOVERY IN OVER-THE-AIR TRANSMISSION

(71) Applicant: Eric DERBEZ, Vancouver (CA)

(72) Inventor: Eric Derbez, Vancouver (CA)

(21) Appl. No.: 14/440,508

(22) PCT Filed: Nov. 1, 2013
(86) PCT No.: PCT/CA2013/050834

§ 371 Date: May 4, 2015

Related U.S. Application Data
(60) Provisional application No. 61/722,201, filed on Nov. 4, 2012.

(51) Int. Cl. G01S 19/05

(52) U.S. Cl. CPC G01S 19/05

(57) ABSTRACT

A method and apparatus are disclosed for processing and transmitting precise orbit predictions of satellites in a Global Navigation Satellite System such as Navstar-GPS or a communication device such as Iridium which employs force models and curve fitting techniques so encode ephemerides, and particularly ephemerides of duration of a month, in order to minimize bandwidth requirements over-the-air and NVRAM storage requirements. The methods also apply to GNSS constellations such as Galileo or GLONASS.

### FIELD OF INVENTION

The present invention describes a method and apparatus for processing and transmitting precise orbit predictions of satellites in a Global Navigation Satellite System (GNSS), such as Navstar-GPS, so as to minimize over-the-air bandwidth requirements and NVRAM storage requirements by leveraging accompanying broadcast ephemeris or almanac. The methods in this invention also apply to GNSS constellations such as Galileo or GLONASS, COMPASS, and to communication receivers such as Iridium.

### BACKGROUND OF INVENTION

GNSS navigation systems such as Navstar-GPS or GLONASS all require an orbit model (ephemeris) to accompany the measurements (pseudo-ranges) needed to perform a position-fix by triangulation. These models are broadcast by the satellites and are typically valid for 4 hours for GPS & Galileo and ½ an hour for Glonass.

A standard broadcast ephemeris (ICD200 format ephemeris) consists of the following 15 parameters for the orbit model, plus a reference time (TOE) and an ephemeris parameter set identifier (IODE):
A—semi-major axis (the control segment actually transmits A^{1/2})
e—eccentricity
I₀—inclination
Ω₀—line of ascending nodes
ω—argument of the periapsis
M₀—mean anomaly
IDot—rate of change of inclination
OmegaDot—rate of change of the line of ascending nodes
ΔN—correction to the mean motion
CIC—cos amplitude to correct the inclination
CIS—sin amplitude to correct the inclination
CUC—cos amplitude to correct argument of the latitudes
CUS—sin amplitude to correct argument of the latitudes
CRC—cos amplitude to correct radius
CRS—sin amplitude to correct radius
TOE—time of ephemeris—the reference time associated with ephemeris parameters
IODE—issue of data ephemeris—a serial number associated to each ephemeris parameter set intended to distinguish different parameter sets which occur near in time to each other

By encoding 14 to 28 or more days of precise orbit predictions (typically in SP3 format) into a format from which broadcast ephemerides can be recovered, a GPS (or GNSS) capable device can forego decoding the current broadcast ephemeris, thus reducing its time-to-first-fix (TTFF) and saving battery life. This also has the benefit of allowing the device to produce a fix under much more attenuated conditions, since the signal threshold for acquiring and tracking a signal is typically much lower than the threshold required for data demodulation. Thus receiver sensitivity is also enhanced under these attenuated environments.

Typically, consumer GPS receivers can natively handle 4 or 6 hour fits (occasionally the control segment will issue a 6 hour fit ephemeris). The Galileo constellation uses the same navigation message as GPS. By contrast, GLONASS uses a method requiring numerical integration of the initial elements (position and velocity) with some force perturbations; however the Keplerian orbit can be mapped into the GLONASS native format quite easily.

Various methods for processing and transmitting orbit predictions of satellites in such systems have been disclosed in the art. For instance, U.S. Pat. No. 6,651,000 discloses “A method and apparatus for creating and distributing satellite tracking data in a compact format to a remote receiver. At least a portion of the satellite tracking data is extracted from memory and is formatted into a format prescribed by the remote receiver”.

U.S. Pat. No. 6,560,534 teaches how to track satellite data from a plurality of reference stations to generate precise orbit predictions, and fitting these to 6 hour fits using 15 parameter ICD-GPS200format ephemeris, or alternatively shorter duration fits using 9 parameter fits as described in the aforementioned U.S. Pat. No. 6,651,000. Note that a plurality of ephemerides is sent over-the-air to receivers.

U.S. Pat. No. 7,548,200 discloses “Systems, methods and devices for improving the performance of Global Navigation Satellite System (GNSS) receivers”. In particular, the improvement of the ability to calculate a satellite position or a receiver position where a receiver has degraded ability to receive broadcast ephemeris data directly from a GNSS satellite is disclosed. Correction terms can be applied to an approximate long-term satellite position model such as the broadcast almanac. This method does not use numerical integration for orbit recovery.

US patent application number 2007/0299609 presents a method in which the variations in the parameters for the ICD-GPS200 ephemeris format are modeled using either a polynomial or a physical model incorporating gravitational and atmospheric drag effects. However, it does not use numerical integration to recover the orbit prediction.

U.S. Pat. No. 8,242,956 discloses a method using force models on a server to fit a precise orbit prediction, and transmitting the initial elements, position and velocity (c.f. FIG. 2 of the patent) together with certain empirical accelerations, to a client for later orbit recovery. However this method necessitates sending an initial position and velocity (the 6 dimensional ‘orbit state vector’).

### SUMMARY OF INVENTION

The present invention differs from the aforementioned U.S. Pat. No. 8,242,956 in at least two ways. This latter patent discloses a method to transmit an initial position and velocity (‘orbit state vector’ in their language) as well as several empirical acceleration terms, to a client via a communications link. Since these are numerically integrated, they cannot immediately be used for navigation—therefore in typical usage, the current broadcast ephemeris is also sent. There is redundant information contained between the current broadcast ephemeris, and the initial elements.

The present invention also assumes the existence of a broadcast ephemeris—whether transmitted from the server or previously demodulated by the mobile client. However, the present invention uses information derived from any broadcast ephemeris to compute initial elements without sending a separate initial position and velocity (as in U.S. Pat. No. 8,242,956). This is a first benefit A second benefit, is that the payload otherwise used to transmit position and velocity can be used to transmit corrections to the orbit fit; thus month long orbits can be encoded with the same accuracy as 7-10 day orbit predictions.

Specifically, the invention comprises a method for encoding an orbit prediction of a satellite on a computing platform for transmission to a receiver device. The method encodes the orbit prediction over a period of time having a start time T and comprises:
selecting a reference ephemeris model Mₑₚₕ ephemeris whose validity includes T;
selecting a multi-day precise orbit prediction POP;
fitting the initial velocity and empirical accelerations A₀ of model Mₑₚₕ at T to the POP using computationally tractable force models while holding the initial position P₀ from Mₑₚₕ at T fixed;
determining a scalar along-track velocity correction vₐ to the velocity of Mₑₚₕ at T relative to the fitted velocity and empirical accelerations A₀; and
encoding the empirical accelerations A₀ and the scalar along-track velocity correction vₐ. The method can thus use information derived from any broadcast ephemeris to compute initial elements without obtaining, encoding, and sending a separate initial position and velocity vector of the satellite.

In general, the orbit prediction can be decoded or recovered on a mobile or other receiver device by:
obtaining the data encoded according to the aforementioned encoding method via a wired or wireless connection;
computing the satellite position from the model Mₑₚₕ at time T;
computing the satellite velocity from the model Mₑₚₕ at time T;
correcting the satellite velocity at time T with the obtained scalar along-track velocity correction vₐ; and
integrating the satellite position, corrected satellite velocity, and obtained along-track empirical accelerations A₀ using the set of integrated force models (the same as in the encoding) to recover the fit to the POP.

The initial position and velocity vector of the satellite do not need to be transmitted and thus, in the decoding, they are omitted.

In the method, the steps can optionally include determining a scalar radial velocity correction vᵣ to velocity of Mₑₚₕ at T relative to the initial elements I at T. Further, the steps can optionally include determining a scalar cross-track velocity correction v_{c} to velocity of Mₑₚₕ at T relative to the initial elements I at T. These correction terms can then be included in the encoding step when encoding and used later in the correcting step in the decoding.

In certain embodiments, the method can comprise encoding the reference ephemeris model Mₑₚₕ. For instance, this can be done if the reference ephemeris model is not already present at the client.

The reference ephemeris model Mₑₚₕ to be selected can be an ICD-200 ephemeris model. The ICD-200 ephemeris model can be obtained off-air or derived from the POP.

The start time T does not need to be the same as the TOE of reference ephemeris model Mₑₚₕ. However, the start time T can be the TOE.

The POP to be selected can be in SP3 format, for instance with 15 minutes separation between records.

In these methods, the satellite can be a GPS, GNSS, or a QZSS satellite. Further, where the reference ephemeris model Mₑₚₕ is the ICD200 model or the Glonass navigation model, clock error models can also be transmitted. The satellite can also be an Iridium or a LEO satellite

The method can additionally comprise determining an along-track model Mₐ and a cross-track model M_{c} of position errors E between the integrated force models and the POP. For fits up to a week or less, this step may not be necessary. However, it can be desirable for fits when the period of time is equal to or greater than a month. Further, the method can additionally comprise encoding the clock bias, drift, and drift rate.

Further still, the method can comprise an additional fitting to the POP while holding P0 and V_{eff} fixed and allowing A0 to vary.

The invention also comprises servers for encoding an orbit prediction of a satellite which have been programmed to encode the orbit prediction according to the aforementioned methods. The invention also comprises receiver devices for decoding an orbit prediction of a satellite which have been programmed to decode the orbit prediction according to the aforementioned methods. In particular, the receiver can be a GNSS receiver or an Iridium receiver.

An embodiment representative of the entire process of encoding, transmitting, and decoding an orbit prediction according to the present invention can include the following broad steps. For each satellite in a GNSS constellation, the steps are:
(1) (Encoding phase) Obtaining a multi-day Precise Orbit Prediction (POP) as well as an ICD-200 ephemeris model Mₑₚₕ valid for a time span S. The model Mₑₚₕ can be broadcast, or derived from the same POP.
(2) (Encoding phase) Determination of initial elements by fitting to the POP using force models by pinning the initial position at some time T in S to P0 using Mₑₚₕ, but treating the initial velocity V0 and empirical accelerations A0 as free parameters in the fit to the POP.
(3) (Encoding phase) Approximating V0 by a velocity V_{eff} derived from the model's velocity in the radial and along-track corrections—vᵣ and vₐ respectively.
(4) (Encoding phase) Using the force models in (2) with start time T and with initial elements P0, V_{eff} and empirical accelerations A0 to recover the fit to the POP, and comparing the resulting along-track and cross-track position errors with respect to the POP in (1).
(5) (Encoding phase) Fitting the along-track and cross-track position errors E in (4) using appropriate models Mₐ and M_{c} respectively.
(6) (Recovery phase) Sending via wired or wireless means the model Mₑₚₕ, the 2 scalar parameters vᵣ and vₐ to recover V_{eff}, sending the empirical accelerations A0 to recover the low precision orbit prediction in (4), and subtracting the position fit errors E modeled by Ma and Mc in (5),
(7) (Optional Encoding & Recovery phase) Periodically sending updates to a client involving some of the slowly changing parameters in the solar pressure models in (2).

### DESCRIPTION

Herein, the following definitions have been used.

SP3: refers to the National Geodetic Survey Standard GPS Format SP3; the standard format for encoding orbits. See: “Remondi, B. W., 1991: NGS Second Generation ASCII and Binary Orbit Formats and Associated Interpolated Studies, Proceedings of the Twentieth General Assembly, International Union of Geodesy and Geophysics, Vienna, Austria, Aug. 11-24, 1991, 28 pp”.

Pseudo-range: a measurement from a GNSS receiver describing the receiver to satellite range with a receiver bias due to its local oscillator.

ICD-200GPS ephemeris: the 15 parameter ephemeris model described in the Navstar-GPS Interface Control Document ICD-GPS-200, revision C released October 1993. It is sometimes referred to as broadcast ephemeris. This model can be used to compute a satellite's position and velocity anywhere within the model's period of validity.

TOE: Time of ephemeris. The reference time to which the elements of an ephemeris model (such as the ICD-200 GPS) are referenced.

Initial Elements: The position and velocity at reference time T used to integrate the orbit of the satellite via force models. Un-modeled empirical accelerations are considered part of the initial elements herein.

BCE Broadcast Ephemeris: The actual ephemeris model broadcast by a GNSS satellite as demodulated by a receiver.

POP: Precise Orbit Prediction, usually performed with high quality post-processed (historical data) ephemeris data & high fidelity and computationally expensive acceleration models to obtain an accurate ephemeris up to 28 days out.

Clock Model: linear or quadratic polynomial model to account for satellite clock bias and drift over time.

LEO Low Earth Satellite A region of orbital height from the earth occupied by satellites below an altitude of 2,000 kilometres. An example of a satellite system in this region is the Iridium constellation.

MEO Medium Earth Orbit An orbital height from the earth occupied by satellites above Low Earth Orbit and below Geo Synchronous satellites. Constellations using this region are GPS, Galileo and Glonass to name a few.

Mₑₚₕ: an ephemeris model

Force Models: Forces whose sum account for the accelerations undergone by a satellite in an inertial frame (e.g. earth gravity, lunar/solar forces as described in “Satellite Orbits” by Montenbruck & Gill). Some of these forces may be empirical (see below) in that their physical origin is not understood, but nonetheless capture the satellite's dynamics.

Empirical accelerations A0: constant or periodic accelerations in the radial, along, or cross-track directions. They are sometimes considered distinct from solar pressure models, since these can be constructed by a priori physical models (see Montenbruck & Gill Satellite Orbits Models Methods Applications p. 122).

3GPP: the 3rd Generation Partnership Project: a collaboration between groups of telecommunications associations, to make a globally applicable third-generation 3G mobile phone system specification within the scope of the International Mobile Tele communications-200 project of the International Telecommunication Union (ITU).

NVRAM: Non Volatile Random Access Memory (e.g. flash memory).

Radial, Along-track, and Cross-track directions: unit vectors used to decompose orbit modeling errors by projecting orbits errors onto them; their calculation is described below.

Given a position r and its associated velocity v in a reference frame (such as in WGS 84 ECI), for orbits with small eccentricity (i.e. in which the velocity vector is approximately perpendicular to the position vector), new coordinate directions are defined as:
(1) Radial direction

$${x}_{r} {=}^{def} r \text{/} \vert r \vert$$

(2) Cross-track direction

$${x}_{c} {=}^{def} r \times v \text{/} \vert r \times v \vert$$

(3) Along-track direction

$${x}_{a} {=}^{def} r \times {x}_{c} \text{/} \vert r \times {x}_{c} \vert$$

That is, the radius vector to the WGS 84 origin is taken as correct; the along-track vector however will not be perfectly perpendicular to the velocity vector (except at apogee/perigee).

vᵣ: radial velocity correction—see equation (4)

vₐ: along-track velocity correction—see equation (5)

Mₐ: an along-track model of the position errors E between integrated force models and a POP

M_{c}: a cross-track model of the position errors E between integrated force models and a POP

E: position errors determined from the along-track model Mₐ and the cross-track model M_{c}.

A problem addressed by the present invention is that of parametrizing an orbit prediction—typically in SP3 format—such that it is in a compact format for over-the-air transmission, and if desired, can be converted on the GNSS receiver into a format native to the constellation(s) the GNSS receiver uses.

The invention is particularly suitable for application to the Global Positioning System (GPS) satellites, but is also applicable to other Global Navigation Satellite Systems (GNSS) as well as other future satellite systems where the orbits can be encoded in a 15 parameter Keplerian ephemeris. The bit budgets for certain parameters in other constellations may need to be increased—for instance in highly elliptic orbits such as the Japanese QZSS.

The following describes in a preferred embodiment how the models are generally created on a server, what information needs to be transmitted (from server to receiver), and how the models are generally recovered at a GNSS receiver device.

Model Creation (server side—encoding of over-the-air model)

There are several commercial software packages available to perform precise orbit predictions given historical accurate post-fact orbit determination data. One such package is provided by MicroCosm; another is Bernese.

There are also several well known methods for those skilled in the art to fit 4 (or 6) hour ICD-200 models to SP3 precise orbit predictions. These four hour fits would be just as suitable for this method as original broadcast ephemeris (BCE) models.

The heart of the model creation lies in fitting (for instance), a month's worth of precise orbit prediction data to a force model. The initial position at time T for the force model is that given by an ICD-200 format ephemeris (possibly a BCE), denoted herein as Mₑₚₕ, where T lies within its usability range. In particular, T need not be the TOE. The fit will determine an initial velocity, and the difference between the initial velocity and the velocity computed from the above mentioned Mₑₚₕ is then decomposed into radial and along-track corrections. It is the scalar magnitudes of these radial and along track corrections which are transmitted to the client rather than the initial position and velocity vectors as in U.S. Pat. No. 8,242,956. In a preferred embodiment, only the along-track correction is transmitted; in this last case only a single scalar needs to be transmitted as opposed to 2 three-dimensional vectors (a big savings on L-Band satellite downlinks).

Specifically, if at t0 we let P0 be the position from the model Mₑₚₕ; we can then optimize a fit for V0 and empirical accelerations A0 for the POP.

If we define V_{M} to be the velocity of the model at T, and

Vₑᵣᵣ=V0−V_{M}, to be the correction between the optimal velocity vector which fits the POP, then
(4) vᵣ=Vₑᵣᵣ·xᵣ from equation (1) using the model Mₑₚₕ, and
(5) vₐ=vₑᵣᵣ·xₐ from equation (3) using the model Mₑₚₕ.

Whence
(6) V_{eff=}V_{M+}vᵣxᵣ₊vₐxₐ

(In other words, V_{eff} is the projection of V0 onto the subspace spanned by the radial and along-track vector at T).

Note that if desired, one could compute the cross-track correction to V0 via:
(7) vₒ=vₑᵣᵣ·x_{c} from equation (2) using the model Mₑₚₕ.

Then,

Fixing P0 and V_{eff} one can then vary the empirical accelerations A0 to optimize a fit over the POP.

Finally, the along-track and cross-track position errors E (in some inertial frame) of the fit with respect to the POP can be recorded and parametrized by some appropriate models Mₐ & M_{c} to be later subtracted on the client device. The along and cross-track position errors are obviously computed with respect to the orbit fit using P0 and V_{eff} and the empirical accelerations A0 as initial elements for the numerical integration.

Optionally, a second fit with P0 and V_{eff} both fixed but A0 allowed to vary can be performed. The new empirical accelerations might yield a better fit. Note that the model recovery steps on the client are unaffected by this extra fit.

Values for the clock bias, drift and drift-rate (a_{f0}, a_{f1}, a_{f2}) are also calculated as to be referenced to T and are also transmitted.

Information Transmitted

In this preferred embodiment, the following data are transmitted over-the-air from the server to the GNSS receiver:
a 15 parameter ICD-200 ephemeris model Mₑₚₕ

(Optionally the server can omit the ephemeris if the TOE and week number of the last known ephemeris that the receiver demodulated is sent to the server. The server can then look-up this ephemeris and build the payload based on that ephemeris.)
a reference time T to compute the initial position and velocity of the ephemeris for calculating initial elements for using force models. Note that T need not be the TOE of the ephemeris.
radial and along-track corrections vᵣ & vₐ to the velocity of the initial elements (2 parameters) (in the preferred embodiment only the along-track correction vₐ is sent)
along-track empirical accelerations A₀ to compensate to fit the initial orbit prediction (3 parameters)
along and cross-track position models Mₐ & M_{c} to compensate for post-integration errors (6+4 parameters)
one clock bias a_{f0}, one clock drift an and one drift-rate a_{f2};

Model Recovery (GNSS receiver side—decoding and processing)

Using these models, one can maintain a root-mean-square fidelity of better than 20 m user range error with respect to the POP.

Having received the transmitted data, the client computes the initial position P0 from Mₑₚₕ, and V_{eff} from the radial along-track corrections vᵣ and vₐ applied to the velocity computed from Mₑₚₕ at T. Hence using these initial elements, one can use the same force models on the mobile device as were used on the fit on the server in the model creation step.

Whilst running the force models, the client can interpolate via Chebyshev (or other function bases) the output of the integrator at (for instance) 15 minute intervals.

Before using the interpolated data, the modeled along and cross-track position errors E with respect to the POP are subtracted using Mₐ and M_{c}.

Note that while performing the above calculations, the receiver may immediately use the ICD-200 ephemeris sent by the server (unless the request used only the last known TOE and week number of a stored ephemeris).

Exemplary Data Flow and Computations Summary

The following sections, labeled Server, Over the Air, and GNSS Receiver, summarize the flow of operations in a complete exemplary application of the invention for GNSS.

Server
1) Ingest POP (e.g. in SP3 format) and an ICD-200 format ephemeris:
2) For each satellite use the initial elements in step 1) to compute position along and cross-track position errors E relative to the parent POP and model those errors. The result are coefficients ct_{1, . . . ,} ct₂ for model M_{c} and at₁, . . . , at₆ for Mₐ.

Over the Air

For each satellite, transmit from the server to the GNSS receiver:

the reference time t₀;

the clock bias, drift and drift-rate {a_{f0}, a_{f1}, a_{f2}};

15 parameters for the ICD-200 ephemeris* transmitting these parameters is optional if the client has already sent the TOE and week number of last known ephemeris,

the initial velocity's (optional) radial and along track corrections vᵣ and vₐ;

the force model's empirical along-track corrections A0 (3 parameters);

the model Mₐ for correcting the cross-track position errors (2 parameters); and

the model M_{c} for correction the along-track position error (6 parameters).

GNSS Receiver
1) Using the reference model Mₑₚₕ, compute P0 and Vₘ at the reference time T.
2) Correct the Vₘ using vᵣ and vₐ using equation (6).
3) Using P0 and V_{eff} and A0, and the same force model as on the server to integrate the state of the satellite (for instance) 1 month into the future.
4) While performing step 3), create models which interpolate the integrator output by sampling, for instance, every 15 minutes and store the resulting models.
5) When the client requests ephemeris, index into the correct model, and adjust the clock parameters to the client's request time, compute the position and velocity using the model, and correct by the along and cross-track position error models Mₐ and M_{c} and then map back to a 6 element Keplerian model for use on the client.

While the preceding discussion was directed to the Navstar-GPS constellation, those skilled in the art will appreciate that the present methods can also be applied in other systems as well. For instance in the GLONASS ephemeris model the initial elements (position and velocity) must fall on a 15 minute boundary (Moscow local time) and the GLONASS model is only usable +/−15 minutes on either side of the TOE. For a GLONASS receiver to recover the ephemeris data in its native format, the elements for a GLONASS ephemeris may be created by term-by-term differentiation of the (ICD200GPS) ephemeris model to recover position and velocity. The luni-solar accelerations terms may be set to zero without significantly degrading the accuracy of the model. As mentioned before, the bit budget may have to be modified for highly elliptic orbits such as the QZSS (Quasi-Zenith system planned by Japan).

### EXAMPLE

### Very Low Bandwidth Requirements

This example is a predicted example and illustrates an embodiment of the invention which results in an extremely small size prediction data download package. The bandwidth savings in this particular example can be sketched as follows:

A conventional ICD-200GPS 4-hour ephemeris takes around 45 bytes to encode.

On top of this, using the method of the invention, one can transmit on the order of

2*2 bytes for velocity corrections* vᵣ& vₐ *(in a preferred embodiment only 2 bytes would be used for the along-track correction only)

3*3 bytes for empirical acceleration corrections A₀

6*2 bytes for along-track position correction model Mₐ

2*2 bytes for cross-track position corrections model M_{c}

5 bytes for clock bias and drift

Total transmitted=45+34=79 bytes/satellite for 1 month of data (including BCE model).

Clock bias and drift values can be sent in sec and sec/sec with scale factors of 2⁻³¹ and 2⁻⁴⁵ respectively encoded as a signed 22 and 18 bit integers (for a total of 5 bytes) when encoding a 28 day prediction. For 7 day predictions the drift can be adequately encoded with a signed 16 bit integer with scale factor 2⁻⁴³. These scale factors can accommodate GPS, Glonass, and Galileo.

For a GNSS constellation such as GPS with 30 operational satellites, this procedure could encode 28days with around 2,528 Bytes for 32 satellites for 1 month of data.

Furthermore, if the reference ICD-200 ephemeris (for the initial elements) does not need to be sent, the data amounts to 1088 Bytes (for 32 satellites).

By way of comparison, the method disclosed in U.S. Pat. No. 8,242,956 takes around 2 KB to encode for 32 satellites for a prediction of 7 to 10 days. In another approach, where the model is the GPS Almanac model, instead of transmitting the along-track velocity error, one could consider sending the position and velocity corrections (deltas) with respect to those of the initial elements I (of the fit to the POP) as well as a clock error model. Further, where the model is the GPS Almanac model, and the initial position and velocities used for model recovery are those corrected by the transmitted position and velocities corrections, the clock error model can be recovered. While this approach would also work, the savings in bandwidth would be marginal versus just encoding the full initial elements.

As is evident from this example, there can be a substantial reduction in bandwidth requirements using the technique of the invention.

All of the above U.S. patents and applications, foreign patents and applications and non-patent publications referred to in this specification, are incorporated herein by reference in their entirety.

While particular embodiments, aspects, and applications of the present invention have been shown and described, it is understood by those skilled in the art, that the invention is not limited thereto. Many modifications or alterations may be made by those skilled in the art without departing from the spirit and scope of the present disclosure.

What is claimed is:

1. A method for encoding an orbit prediction of a satellite over a period of time and having a start time T comprising:
selecting a reference ephemeris model Mₑₚₕ whose validity includes T;
selecting a multi-day precise orbit prediction POP;
fitting the initial velocity and empirical accelerations A₀ of model Mₑₚₕ at T to the POP using force models while holding the initial position P₀ from Mₑₚₕ at T fixed;
determining a scalar along-track velocity correction vₐ to the velocity of Mₑₚₕ at T relative to the fitted velocity and empirical accelerations A₀; and
encoding the empirical accelerations A₀ and the scalar along-track velocity correction vₐ.

2. The method of claim 1 comprising:
determining a scalar radial velocity correction vᵣ to velocity of Mₑₚₕ at T relative to the initial elements I at T.

3. The method of claim 2 comprising:
determining a scalar cross-track velocity correction v_{c} to velocity of Mₑₚₕ at T relative to the initial elements I at T.

4. The method of claim 1 comprising encoding the reference ephemeris model Mₑₚₕ.

5. The method of claim 1 comprising selecting the reference ephemeris model Mₑₚₕ to be an ICD-200 ephemeris model.

6. The method of claim 5 wherein the ICD-200 ephemeris model is obtained off-air or derived from the POP.

7. The method of claim 1 wherein the start time T is the TOE of reference ephemeris model Mₑₚₕ.

8. The method of claim 1 comprising selecting the POP to he in SP3 format.

9. The method of claim 1 wherein the satellite is a GPS, GNSS, or a QZSS satellite.

10. The method of claim 1 wherein the satellite is an Iridium or a LEO satellite.

11. The method of claim 1 comprising determining an along-track model Mₐ and a cross-track model Mₒ of position errors E between the integrated force models and the POP.

12. The method of claim 11 wherein the period of time is equal to or greater than a month.

13. The method of claim 1 comprising:
omitting the initial position and velocity vector of the satellite in the encoding.

14. The method of claim 1 additionally comprising:
encoding the clock bias, drift, and drift rate.

15. The method of claim 1 comprising an additional fitting to the POP while holding P₀ and V_{eff} fixed and allowing A0 to vary.

16. A method of decoding an orbit prediction of a satellite comprising:
obtaining the data encoded according to the method of claim 1;
computing the satellite position from the model Mₑₚₕ at time T;
computing the satellite velocity from the model Mₑₚₕ at time T;
correcting the satellite velocity at time T with the obtained scalar along-track velocity correction vₐ; and
integrating the satellite position, corrected satellite velocity, and obtained along-track empirical accelerations A₀ using the set of integrated force models to recover the fit to the POP.

17. A method of decoding an orbit prediction of a satellite comprising:
obtaining the data encoded according to the method of claim 2;
computing the satellite position from the model Mₑₚₕ at time T;
computing the satellite velocity from the model Mₑₚₕ at time T;
correcting the satellite velocity at time T with the obtained scalar along-track velocity correction vₐ and the scalar radial velocity correction vᵣ; and
integrating the satellite position, corrected satellite velocity, and obtained along-track empirical accelerations Aₒ using the set of integrated force models to recover the fit to the POP.

18. A method of decoding an orbit prediction of a satellite comprising:
obtaining the data encoded according to the method of claim 3;
computing the satellite position from the model Mₑₚₕ at time T;
computing the satellite velocity from the model Mₑₚₕ at time T:
correcting the satellite velocity at time T with the obtained scalar along-track velocity correction vₐ, the scalar radial velocity correction vᵣ, and the scalar cross-track velocity correction v_{c}; and
integrating the satellite position, corrected satellite velocity, and obtained along-track empirical accelerations Aₒ using the set of integrated force models to recover the fit to the POP.

19. The method of claim 16 comprising:
determining position errors E from the along-track model Mₐ and the cross-track model M_{c};
and subtracting out the determined position errors E from the integrated satellite positions.

20. The method of claim 16 comprising:
omitting the initial position and velocity vector of the satellite in the decoding.

21. A server for encoding an orbit prediction of a satellite comprising a server which has been programmed to encode the orbit prediction according to the method of claim 1.

22. A receiver device for decoding an orbit prediction of a satellite comprising a receiver device which has been programmed to decode the orbit prediction according to the method of claim 16.
